(19) United States
(12) Patent Application Publication
(10) Pub. No.: US 2003/0215221 A1
(43) Pub. Date: Nov. 20, 2003

(54) Video-recording apparatus

(76) Inventors: Eiichi Hatae, Kaho-Gun (JP); Shiro Iwasaki, Iizuka (JP); Hiroyuki Yoshida, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/383,765

(22) Filed: Mar. 10, 2003

(30) Foreign Application Priority Data
Mar. 8, 2002 (JP) 2002-063311

(51) Int. Cl. H04N 5/781

(52) U.S. Cl. 386/125; 386/126

(57) ABSTRACT

A video-recording apparatus including an I/O unit for both reading and writing data to a recording medium, a tuner for acquiring video data, an input unit for receiving input from a user, and a control unit. The control unit permits the I/O unit to execute user recording when user recording conditions specified through the input unit are satisfied, but unless otherwise the control unit permits the I/O unit to temporarily record the video data obtained by the tuner. Video data obtained by the user recording and that obtained by temporary recording are recorded on the recording medium at the same region of the recording medium.

### BACKGROUND OF THE INVENTION

1. Field of the Invention

The present invention relates to a video-recording apparatus for recording video data onto a recording medium such as a hard disk and an optical magnetic disk.

2. Description of the Related Art

There is a recent trend in shift of a recording medium in a video-recording apparatus from a sequentially recordable recording medium such as VHS videotape toward a non-volatile recording medium capable of recording video data at random, such as a hard disk, an optical disk, and a flash memory.

In such a video-recording apparatus, a user practices explicit recording of a program, or otherwise timer-controlled recording of the program, thereby allowing the recording medium to record video data that the user wants. This recording method is herein called “user recording”.

Some of the above video-recording apparatus are designed to self-record the video data onto the recording medium without the “user recording”. This alternative recording method is herein called “temporary recording”.

The temporary recording often records video data obtained by a video data-acquiring unit such as a tuner. Now, assume that the user watches a program when a certain time elapses after the program starts. The use of the temporary recording allows a heading part of the program, which the user missed watching, to be temporarily recorded onto the recording medium. Consequently, the user can watch the missed part of the program later. This functionality is referred to as a near-video-on-demand function. The near-video-on-demand function may be added to the video-recording apparatus to provide improved convenience of the user.

However, the recording medium has a limited recording capacity. Therefore, the continued temporary recording results in shortage of the recording capacity of the recording medium. As a result, further temporary recording must be stopped.

A prior art addressing such shortcomings is disclosed in the published Japanese Patent Applications Laid-out Nos. 7-135632 and 2000-184320.

According to the prior art as mentioned above, however, the recording medium is distinctly divided into two parts, i.e., temporary recording and user recording areas.

FIG. 6(a) is a simulated illustration, showing a relationship between the temporary recording and user recording areas. In FIG. 6(a), the recording medium has an effective region 100 (size “S”) divided into a user recording-dedicated area 101 (size “S1”) and a temporary recording-dedicated area 102 (size “S2”), where S=S1+S2.

As illustrated in FIG. 6(b), the temporary recording-dedicated area 102 forms a roll buffer. In the roller buffer as illustrated in FIG. 6(b), video data have already temporarily been recorded on first and second segments 201, 202, but a third segment 203 is vacant.

In this situation, the next video data to be temporarily recorded are recorded onto the third segment 203, and the roll buffer becomes full of the video data. The subsequent video data to be temporarily recorded thereafter are overwritten onto the first segment 201. As a result, the old video data present in the first segment 201 until the new video data is overwritten thereon are lost.

As discussed above, the areas 101, 102 are fixedly and distinctly divided. The size “S2” (=S−S1) of the temporary recording-dedicated area 102 is pressed by the size “S1” of the user recording-dedicated area 101. As a result, the roller buffer tends to suffer from capacity shortage.

Even when the user recording-dedicated area 101 has a sufficient space to store the temporarily recorded video data, the temporarily recorded video data cannot be recorded onto the user recording-dedicated area 101, instead of being recorded onto the temporary recording-dedicated area 102 that is full with the data. Such an inconvenience makes it difficult to effectively use the entire size “S” of the effective region 100.

More specifically, there is a problem of a reduction in temporarily recordable time with reference to size “S”.

According to the prior art, the temporarily recorded video data and user-recorded video data are differentiated from one another, depending upon regions where these two different video data are recorded. For example, when the user wants to convert the temporarily recorded video data into the user-recorded video data in order to treat the temporarily recorded video data as user-recorded video data, then the only thing that the user can do is forcedly move the temporarily recorded video data from the temporary recording-dedicated area 102 to the user recording-dedicated area 101. In short, a problem associated with the prior art is that the video data is complicated and difficult to handle.

As a consequence, such a change in handling the video data is virtually impossible to make, unless the video-recording apparatus is provided with a user interface for supporting the area-to-area movement of the video data.

### OBJECTS AND SUMMARY OF THE INVENTION

In view of the above, an object of the present invention is to provide a video-recording apparatus operable to effectively use the entire recording medium to provide a longer temporary recordable time, and operable to flexibly treat video data.

A first aspect of the present invention provides a video-recording apparatus operable to record, onto a recording medium, both video data obtained by user recording and video data obtained by temporary recording, in which the former and the latter video data are recorded on the recording medium at the same region of the recording medium.

A second aspect of the present invention provides a video-recording apparatus comprising: a recording medium operable to store data in a both writable and readable manner; a read-write unit operable to both read and write the data to the recording medium; a video data-acquiring unit operable to acquire video data; an input unit operable to receive input from a user; and a control unit operable to control the read-write unit, the video data-acquiring unit, and the input unit, in which the control unit permits the read-write unit to execute user recording when a user recording condition specified through the input unit is satisfied, but unless otherwise the control unit permits the read-write unit to temporarily record the video data obtained by the video data-acquiring unit, wherein video data obtained by the user recording and video data obtained by temporary recording are recorded on the recording medium at the same region of the recording medium.

In the above structure, the video data obtained by the user recording and that obtained by the temporary recording are recorded on the recording medium at the same region thereof. As a result, when a void space is present in the region, then the video data obtained by the temporary recording can continuously be recorded. This feature achieves effective use of the recording medium, thereby providing a longer temporarily recordable time.

As discussed above, the video data obtained by the user recording and that obtained by the temporary recording are recorded on the recording medium at the same region thereof. This feature eliminates the need to move the video data to another region of the recording medium, and consequently achieves flexible handling of the video data.

A third aspect of the present invention provides a video-recording apparatus as defined in the second aspect of the present invention, further comprising: a compression unit disposed between the video data-acquiring unit and the read-write unit, the compression unit being operable to compress the video data acquired by the video data-acquiring unit, and to feed the compressed video data into the read-write unit.

The above structure is capable of recording compressed and smaller-sized video data onto the recording medium. This feature realizes further effective use of the recording medium.

A fourth aspect of the present invention provides a video-recording apparatus as defined in the second aspect of the present invention, wherein the video data recorded on the recording medium are managed in accordance with attribution information associated with the video data, and wherein the attribute information includes identification information that distinguishes the video data obtained by the user recording from the video data obtained by the temporary recording.

As a result, referencing such identification information contained in the attribute information distinctly differentiates the video data obtained by the user recording from the video data obtained by the temporary recording, although these two different video data are recorded and scattered in the recording medium at the same region thereof.

A fifth aspect of the present invention provides a video-recording apparatus as defined in the fourth aspect of the present invention, wherein the identification information can be rewritten by input from the user through the input unit.

As a result, the video data obtained by the user recording and the video data obtained by the temporary recording are interchangeable according to user's requests.

The video data are usually large in size. According to the present invention, such large-sized video data need not be changed at all. Accordingly, rewriting the identification information that is considerably smaller in size than the video data is an easy job for the video-recording apparatus. As a result, the user can accomplish a purpose merely by practicing such easy processing.

A sixth aspect of the present invention provides a video-recording apparatus as defined in the second aspect of the present invention, wherein the control unit permits the read-write unit to practice reduction processing to reduce an information quantity of the video data recorded on the recording medium when the recording medium runs out of a void recording space, and when a predetermined condition is satisfied.

The above structure allows the video data to be recorded without a reduction in the video data when the recording medium has a sufficient void space, and further allows new video data to be recorded by reducing the video data on the recording medium when the recording medium runs out of the void space.

A seventh aspect of the present invention provides a video-recording apparatus as defined in the sixth aspect of the present invention, wherein the reduction processing reduces the video data obtained by the temporary recording in preference to the video data obtained by the user recording.

As a result, the video data obtained by the user recording can be protected.

An eighth aspect of the present invention provides a video-recording apparatus as defined in the sixth aspect of the present invention, wherein the attribute information includes earlier and later recording time of the video data, and wherein the reduction processing reduces video data having the earlier recording time in preference to video data having the later recording time.

As a result, old, non-fresh pieces of video data are usually reduced in sequence, thereby allowing new video data to be recorded on the recording medium.

A ninth aspect of the present invention provides a video-recording apparatus as defined in the sixth aspect of the present invention, wherein the reduction processing is executed on a program basis.

As a result, the video data can conveniently be reduced for each program.

A tenth aspect of the present invention provides a video-recording apparatus as defined in the sixth aspect of the present invention, wherein the reduction processing is executed on a partial program basis.

The above structure provides video data having part of the program remaining recorded.

An eleventh aspect of the present invention provides a video-recording apparatus as defined in the sixth aspect of the present invention, wherein the attribute information includes protection information to both prohibit and allow the reduction processing of the video data, the protection information being rewritable according to input from the user through the input unit, and wherein video data having the protection information to prohibit the reduction processing is never reduced.

As a result, the user can save important video data for a long time by specifying the protection information.

A twelfth aspect of the present invention provides a video-recording apparatus as defined in the sixth aspect of the present invention, wherein the reduction processing deletes the video data.

As a result, the video data are sequentially deleted, thereby providing an enlarged void space in the recording medium.

A thirteenth aspect of the present invention provides a video-recording apparatus as defined in the sixth aspect of the present invention, wherein the reduction processing compresses the video data at a ratio greater than that of the video data that are stored at present.

As a result, the compressed and smaller-sized video data provides a void space in the recording medium. In addition, the compression of the video data allows the user to ascertain what the compressed video data contains.

A fourteenth aspect of the present invention provides a video-recording apparatus as defined in the fourth aspect of the present invention, wherein the attribute information is retained in a table different from the video data.

The above structure realizes easy, high-speed search and edit of the attribute information.

A fifteenth aspect of the present invention provides a video-recording apparatus as defined in the fourth aspect of the present invention, wherein the attribute information is retained as a header of the video data.

As a result, the video data and the attribute information can unitarily be treated.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating a video-recording apparatus according to an embodiment of the present invention;

FIG. 2(a) is a descriptive illustration, showing a recording medium for use in the video-recording apparatus;

FIG. 2(b) is an exemplified illustration, showing a table for retaining attribute information;

FIG. 2(c) is an illustration, showing a data structure that comprises the attribute information and video data;

FIG. 3 is a flowchart, showing how the video-recording apparatus is operated;

FIG. 4 is a flowchart, illustrating how recording processing is practiced;

FIG. 5(a) is a descriptive illustration, showing a region of the recording medium;

FIG. 5(b) is a simulated illustration, showing a roll buffer;

FIG. 6(a) is descriptive illustration, showing a region of a prior art recording medium; and

FIG. 6(b) is a simulated illustration, showing a prior art roller buffer.

### DETAILED DESCRIPTION-OF THE PREFERRED EMBODIMENT

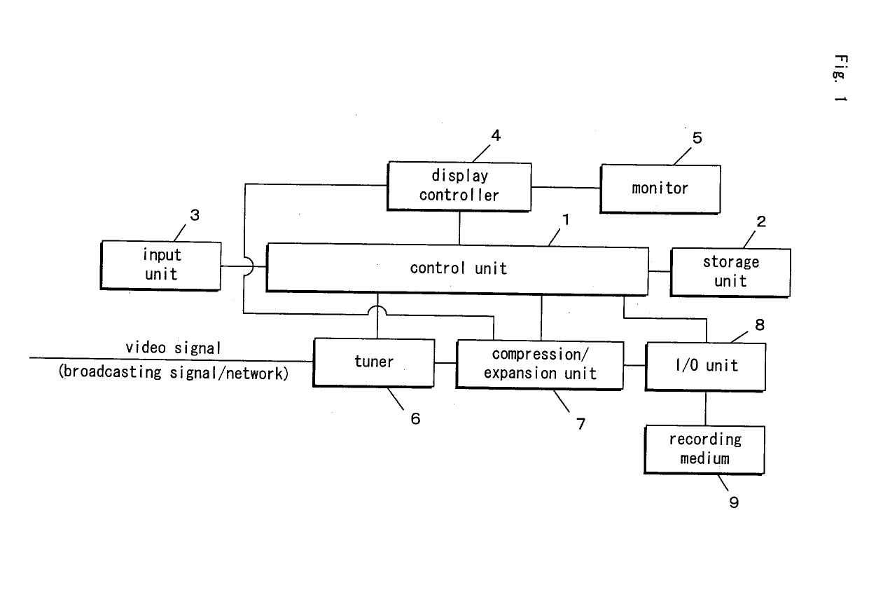

An embodiment of the present invention will now be described with reference to the drawings. FIG. 1 is a block diagram, illustrating an exemplary video-recording apparatus according to an embodiment of the present invention.

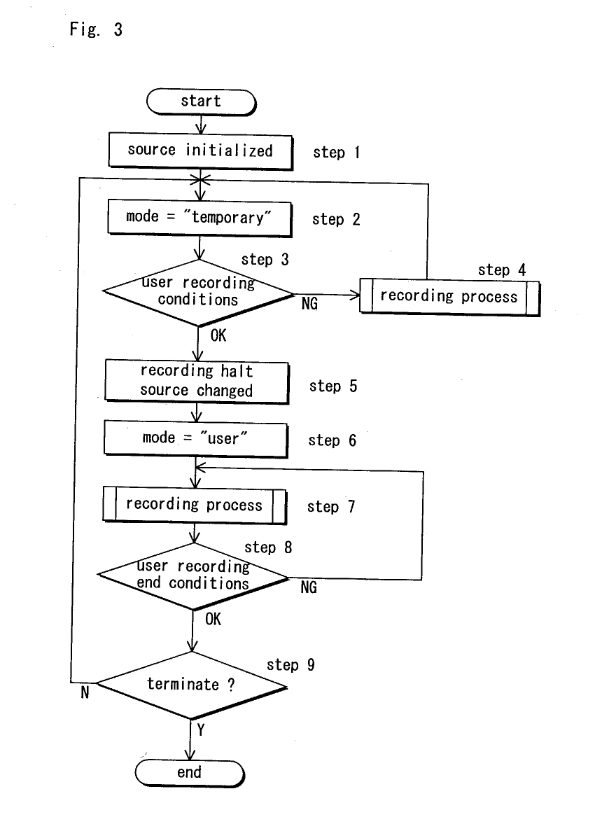

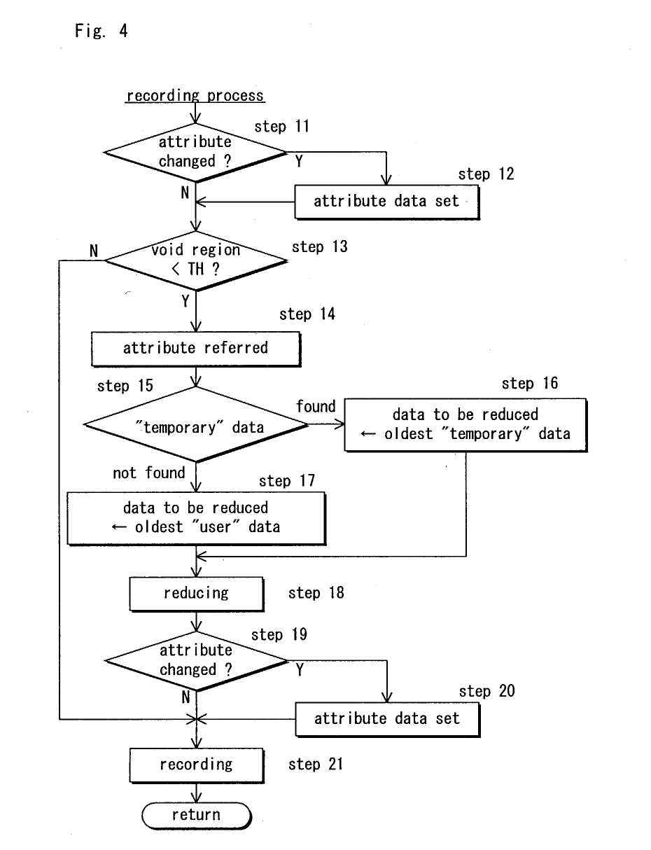

In FIG. 1, a control unit 1 includes a CPU (central processing unit) and a ROM (read only memory). The CPU controls the components illustrated in FIG. 1. The operations of the components as described below occur under the control of the CPU. Also, the performance of the various processing by the CPU may be considered as part of the control function of the CPU. The ROM stores a program according to flowcharts of FIGS. 3 and 4. The CPU executes the program.

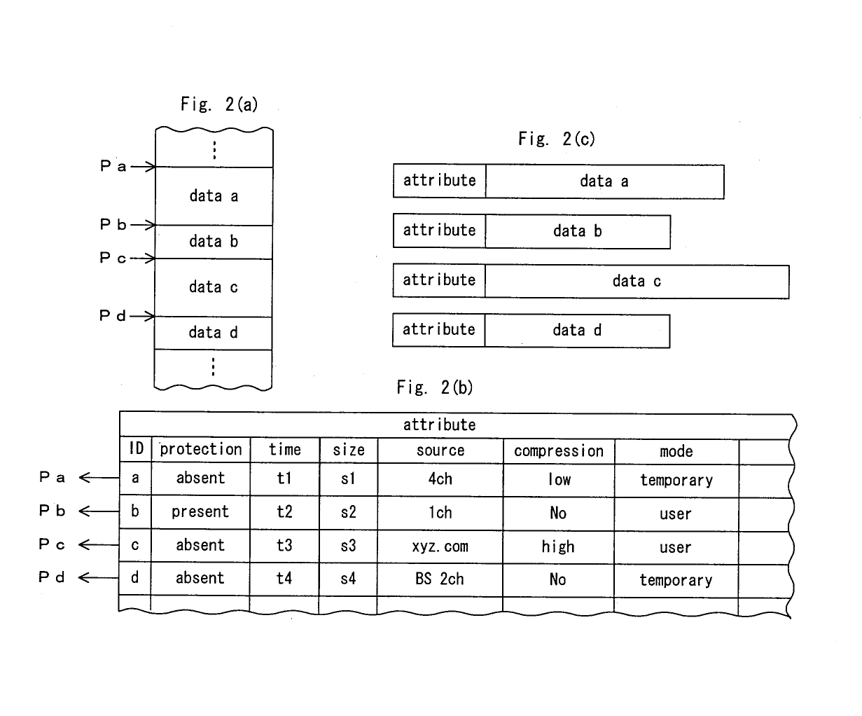

A storage unit 2 includes a RAM (random access memory). The storage unit 2 is provided with an area in which information required to allow the control unit 1 to execute processing is temporarily stored. The storage unit 2 contains an attribute information table as illustrated in FIG. 2(b). Part of the storage unit 2 may be used as a cache of a recording medium 9.

An input unit 3 includes a keyboard and a remote controller. The input unit 3 receives input from a user. The user's input entered from the input unit 3 includes user's explicit video-recording operations, user's timer-controlled recording operations, and other user's operations. The user's timer-controlled recording operations may be the inputting of source information such as channels and a recording start-end time. The user's timer-controlled recording operations further may be the specifying of programs using either a G-code or EPG information. In particular, according to the present embodiment, the user can enter attribute information and a change in the attribute information using the input unit 3. The attribute information will be discussed later.

A display controller 4 and a monitor 5 may be separated from the video-recording apparatus. Video data either fed from a tuner 6 or read out from the recording medium 9 is entered into a compression-expansion unit 7 to regenerate the video data. The display controller 4 receives image data from the compression-expansion unit 7. The video data includes a plurality of types of image data. Such image data may be of either field or frame structure. The display controller 4 feeds a video signal into the monitor 5. The monitor 5 is a display device such as a cathode-ray tube, an LCD, or a plasma display, and displays a picture to the user in accordance with the received video signal.

The tuner 6 corresponds to a video data-acquiring unit for acquiring the video data. The tuner 6 obtains the video data via an either broadcasting signal or network.

The compression-expansion unit 7 has a compression unit positioned between the video data-acquiring unit (the tuner 6) and a read-write unit (an I/O unit 8). The compression unit functions as a data-compressing unit for compressing the video data. According to the present embodiment, the compression-expansion unit 7 compresses and expands the video data in accordance with MPEG specifications, but may alternatively processes the video data in accordance with other systems. The data-compressing unit may be omitted when no video data must be compressed and when pre-compressed video data are used.

The I/O unit 8 works as the read-write unit for both reading and writing the video data to the recording medium 9.

The recording medium 9 is a non-volatile medium such as a hard disk, an optical disk, and a flash memory. The video data can be read and written to the recording medium 9 at random. The recording medium 9 is desirably formed to work as a series of storage areas when being viewed from the control unit 1. Accordingly, the recording medium 9 may be, e.g., a combination of a hard disk and an optical disk. However, in order to form the recording medium 9 in combination of mediums having different access speeds, the recording medium 9 is desirably provided with a cache for absorbing a difference in access speed.

The following discusses with reference to FIG. 2 the way in which the video data are recorded when being viewed from the control unit 1, and the way in which the attribute information is constructed.

As previously discussed, the recording medium 9 can be treated as a series of storage areas when being viewed from the control unit 1. For example, as illustrated in FIG. 2(a), successive pieces of video data such as data “a”, “b”, “c”, “d” etc. are recorded on the recording medium 9. The data “a”, “b”, “c”, “d” etc. may be video data obtained by user recording, or otherwise may be video data obtained by temporary recording, or alternatively may be a combination of these two different video data.

This means that respective pieces of video data obtained by the user recording and the temporary recording are recorded over the same successive regions. In general, the video data obtained by the user recording and that obtained by the temporary recording are recorded and scattered in random order. As shown in FIG. 2(a), “pa”, “pb”, “pc”, and “pd” are pointers that point respective heads of the data “a”, “b”, “c”, and “d”.

The attribute information is managed in accordance with a table as illustrated in FIG. 2(b). In FIG. 2(b), fields such as ID, protection, time, size, source, compression, mode, etc. are defined as attributes.

The “ID” field provides an identifier of each piece of the video data. The “ID” field comprises names such as “a”, “b”, “c”, “d”, etc. and pointers “pa”, “pb”, “pc”, “pd”, etc. The control unit 1 in receipt of any ID is free to access a corresponding piece of video data in the recording medium 9 through the I/O unit 8. Since the distinguishment of the video data using the ID is all that is actually required, the ID's are desirably defined to allow the control unit 1 to establish a unique relationship to each piece of the video data.

The “mode” field provides a flag showing either the video data obtained by the temporary recording (a “temporary” mode) or that obtained by the user recording (a “user” mode). The control unit 1 differentiates each piece of the video data in accordance with the flag, thereby making it possible to recognize that the video data is obtained by either the temporary recording or the user recording.

When the user wants to treat temporarily recorded video data as video data manually recorded by the user, or on the contrary, the user should rewrite the flag of the video data and need not to process the video data itself as illustrated in FIG. 2 (a) at all. In this instance, the user can rewrite the flag using the input unit 3. As a consequence, the user can accomplish a purpose with ease. In addition, the video-recording apparatus can complete processing with ease at very high speed because rewriting the flag is all that is required. That is, heavily loaded processing such as movement of larger-sized video data is not required.

The protection field comprises two different flags that show “present” and “absent”. When the protection field shows “present”, then a reduction in the video data having such a protection filed is prohibited. Conversely, the reduction is allowed when the video data has the protection field showing “absent”.

The time field provides data on a video recording start time. The data is specified on a, e.g., second time basis.

The size field provides data on a size of the video data. The data is specified on a, e.g., byte basis.

The source field provides data on a place where the video data is obtained. For example, video data having an ID of “a” is shown obtained by the tuner 6 from a fourth channel of broadcast waves. Video data having an ID of “c” is shown obtained from a certain web site on the Internet. An address of the web site on the Internet is recorded at the source field.

The compression field provides data on how much the video data is compressed. The compression field according to the present embodiment provides three different values, i.e., “No” (not compressed), “low” (lightly compressed), and “high” (highly compressed). This is merely an example, and such compression values may be expressed using other indexes.

Any of the above field values may be omitted if needed. Alternatively, the attribute information may include further fields. The order of the fields, of course, may be changed when necessary.

The user can edit the field values using the input unit 3. At this time, the data as illustrated in FIG. 2(b) may be tabulated as a user interface. Such a tabulated user interface as one example may be provided in a manner nearly the same as FIG. 2(b). Accordingly, a drawing showing the tabulated user interface is herein omitted in order to avoid duplicated drawings.

The control unit 1 produces image data from the table of FIG. 2(b) in accordance with the attribute information as illustrated in FIG. 2(b). The storage unit 2 stores the attribute information. The control unit 1 provides display control for the monitor 5 through the display control unit 4. Based on the display control, the monitor 5 displays the produced image data to the user.

As illustrated in FIG. 2(c), a file or stream provided with header and data sections may be used as an alternative to FIG. 2 (b). The header section contains the attribute information. The data section contains a data entity from the video data. This alternative provides easy handling because the video data and attribute information can be duplicated and/or moved together when the video data is duplicated and/or moved from the recording medium 9 to another recording medium.

Meanwhile, the management of the attribute information using the table as illustrated in FIG. 2(b) completes processing with ease at high speeds when the control unit 1 searches the storage unit 2 for required information in the attribute information, when the control unit 1 edits a particular field of the attribute information, and when the control unit 1 provides access to video data having a particular ID.

The following discusses with reference to FIGS. 3 and 4 how the video-recording apparatus constructed as above will be operated.

At step 1 of FIG. 3, when the video-recording apparatus is activated, the control unit 1 initializes a source, from which the tuner 6 obtains the video data. In this instance, the source may be a source that was being watched immediately before electric power to the video-recording apparatus was shut off.

The tuner 6 obtains the video data from the initialized source, and then starts to deliver the obtained video data to the compression-expansion unit 7.

The control unit 1 reserves a “mode” (“temporary” or “user”) storing area in the storage unit 2 at a particular region thereof in order to differentiate the temporary recording from the user recording.

At step 2, the control unit 1 sets a mode value of the storage unit 2 into the “temporary” mode. The video-recording apparatus starts to execute the temporary recording.

At step 3, the control unit 1 checks user recording conditions to see whether these conditions are fulfilled. The user can enter the user recording conditions using the input unit 3. The user recording conditions include the practicing of explicit recording operations or the satisfying of timer-controlled recording conditions.

When the user recording conditions are unsatisfied, then the routine is moved to step 4, at which recording processing as discussed later in detail is practiced as illustrated in FIG. 4. However, the recording processing addresses the temporary recording.

When the recording processing at step 4 is completed, the routine is returned to step 2, at which the control unit 1 starts the processing. This means that the temporary recording according to step 4 is continuously performed while the user recording conditions remain unsatisfied at step 3. As a result, a series of video data obtained by the temporary recording are sequentially accumulated in the recording medium 9.

Meanwhile, when the user recording conditions are satisfied at step 3, then the control unit 1 performs user recording processing according to step 5 to step 8 as described below.

At step 5, the control unit 1 stops further temporary recording, and then changes the source, from which the tuner 6 obtains the video data, to a source specified by the user.

At step 6, the control unit 1 sets the mode value of the storage unit 2 into the “user” mode. At step 7, the control unit 1 starts to execute the recording processing as illustrated in FIG. 4. Different from the recording processing at step 4, the recording processing at step 7 handles the user recording.

At step 8, the control unit 1 checks user-recording end conditions to see whether such conditions are fulfilled. The user-recording end conditions include the end of a program specified by the explicit recording operations and the reaching of a recording end time specified by the timer-controlled recording conditions.

When the determination in step 8 results in a negative answer, then the routine is returned to step 7, at which the control unit 1 performs the processing. Consequently, the user recording according to step 7 is continuously performed while the user-recording end conditions remain unsatisfied. As a result, a series of video data obtained by the user recording are sequentially accumulated in the recording medium 9.

When the user-recording end conditions are fulfilled at step 8, then at step 9, the control unit 1 ascertains that there are no instructions to terminate the operations, and then the routine is returned to step 2, at which the control unit 1 starts to perform the temporary recording.

The following discusses with reference to FIG. 4 the way in which the recording processing is performed at steps 4 and 7.

As illustrated by step 11 of FIG. 4, the control unit 1 checks the attributes, i.e., the values in the fields as shown in FIG. 2(b), before starting the recording processing, in order to see whether there is a change in the attributes.

When there is a change in the attributes, then at step 12, the control unit 1 sets a value to a corresponding field of the attribute information associated with the video data.

According to the present embodiment, as to a program that the user watches through the monitor 5, the control unit 1 puts “present” into the protection field associated with video data obtained by temporarily recording the program.

Consequently, the video data obtained by temporarily recording the program that the user is watching at present is excluded from data to be reduced as discussed later. This feature protects a heading program portion that the user missed watching, when the user watches a program that was already started to broadcast. As a result, the user can enjoy a near-video-on-demand function, thereby providing improved convenience.

At step 13 of FIG. 4, the control unit 1 checks the recording medium 9 to see whether the recording medium 9 has a sufficient void region.

According to the present embodiment, threshold value “TH” is predetermined. The control unit 1 compares threshold value “TH” with a size of the void region. When the void region is less in size than threshold value “TH”, the control unit 1 determines that the void region in the recording medium 9 is insufficient. Unless otherwise, the control unit 1 determines that a sufficient void region is available in the recording medium 9.

When the recording medium 9 has such a sufficient void region, the routine is advanced to step 21, at which the control unit 1 continues to execute the recording processing.

When the recording medium 9 runs short of a void region, then the control unit 1 performs processing according to steps 14 and greater. More specifically, at step 14, the control unit 1 references the attribute information to select video data to be reduced. Reducing of data refers to deletion, compression, or a combination of both. During such selection, video data having the protection field set as “present” are exempt from the video data reduction.

At step 15, the control unit 1 checks a gang of video data to examine whether there is video data in the “temporary” mode. When the video data in the “temporary” mode is found to be present, then at step 16, the control unit 1 selects the oldest, non-fresh video data from among the “temporary” mode video data, and then sets the selected data as video data to be reduced.

When no “temporary” mode video data is found at step 15, then at step 17, the control unit 1 selects video data obtained by the user recording to set the selected data as video data to be reduced. In this instance, the oldest, non-fresh video data among the selected data is preceded as the video data to be reduced.

In this way, the control unit 1 selects the video data to be reduced. According to the present embodiment, the video data obtained by the temporary recording are reduced in preference to the video data obtained by the user recording. In addition, later recorded video data are reduced in preference to earlier recorded video data.

At step 18, the video data to be reduced as mentioned above is reduced. The video data to be reduced may be reduced on a program basis, or otherwise may be reduced on a partial program basis (e.g., on the basis of the number of certain frames).

Alternatively, the video data to be reduced may be deleted. Consequently, all of the video data to be reduced may sequentially be deleted. As a result, the recording medium 9 can have an enlarged void space. In this instance, the attribute information of the deleted video data is, of course, deleted as well.

As a further alternative, the video data to be reduced may be compressed at a ratio higher than that of the non-reduced video data. As a result, the compressed video data is reduced in size, thereby providing a void space in the recording medium 9. The compression of the video data allows the user to ascertain what the compressed video data contains.

The attribute information of the compressed video data is not deleted. At this time, the compression field of the attribute information has values varied from “No” to “low” and from “low” to “high”.

The compression as discussed above includes logical video data compression other than physical video data compression. More specifically, in the theoretical compression, the video data is erased, but information to re-obtain the video data is left available. In this instance, the source field of the attribute information contains data on a position where the video data is re-obtainable. For example, an URL on the Internet, or otherwise a position where an either storage service or a download service is available may be filled in at the source field.

As a yet further alternative, the video data to be reduced may be reduced in combination of deletion and compression.

When the reduction as discussed above is completed, then at step 19, the control unit 1 checks the reduced video data to see whether the attributes of the reduced video data remain unchanged. In general, the attributes of the reduced video data are varied. When there is a change in the attributes, then at step 20, the control unit 1 places such a change into the attribute information.

When the above processing is completed, then the routine is moved to the next step from the recording processing while the control unit 1 continues to execute the recording processing at step 21.

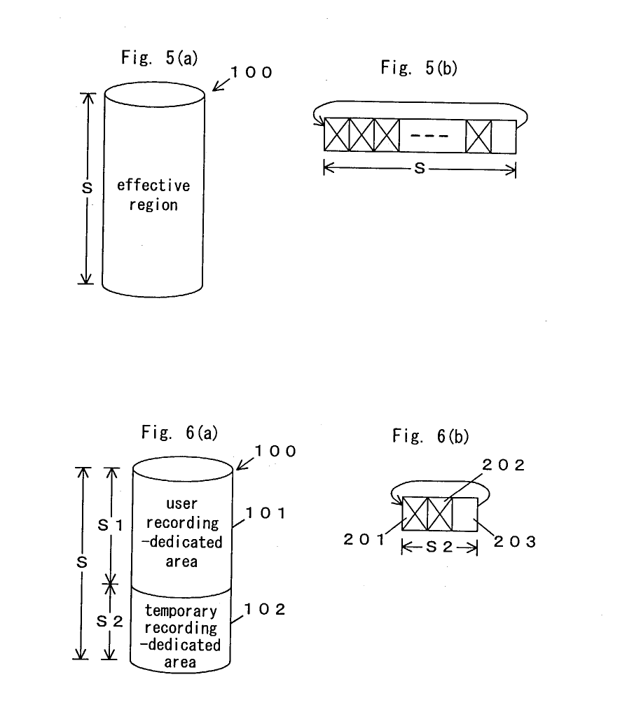

The following simultaneously discusses with reference to FIG. 5 the way in which the video data are treated according to the present embodiment.

As illustrated in FIG. 5(a), according to the present embodiment, an effective region 100 comprises a series of recording areas. The video data obtained by the temporary recording and that obtained by the user recording are recorded and scattered in the same area “S”.

Although such two different types of video data are stored and mixed together in the same region, the attribute information as shown in FIG. 2(b) immediately differentiates the video data obtained by the temporary recording from that obtained by the user recording.

As illustrated in FIG. 5(b), a large-sized roller buffer covers the entire area of the effective region 100 (size “S”), and consequently the roller buffer has a size equal to the size “S” of the effective region 100.

As evidenced by a comparison of FIG. 5(b) with FIG. 6(b), pursuant to the present embodiment, the recording medium 9 can store a large volume of video data by using the effective region 100 of the recording medium 9 to the greatest extent possible. In other words, size “S” provides a temporarily recordable time considerably greater than that obtained according to the prior art.

Pursuant to the present invention, the video data obtained by the temporary recording and that obtained by the user recording are recorded on the recording medium at the same region thereof. This feature achieves the efficient use of the recording medium, and realizes recording that meets requirements of the user.

In addition, the video data obtained by the user recording as well as that obtained by the temporary recording may be reduced when the recording medium runs out of a recording capacity. This feature allows a newer program to be recorded, and realizes recording that satisfies the requirements of the user.

Furthermore, the user can convert between the video data obtained by the temporary recording and that obtained by the user recording by changing the attribute information. This feature provides easy data management.

Moreover, the protection data of the attribute information protects video data that the user wants to save. This feature realizes program accumulation that the meets the requirements of the user.

Furthermore, pursuant to the present invention, the video data that the user is watching is never reduced. This feature allows the user to retroactively re-watch a picture that is being replayed at present.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A video-recording apparatus operable to record, onto a recording medium, both video data obtained by user recording and video data obtained by temporary recording, in which the former and the latter video data are recorded on said recording medium at the same region of said recording medium.

2. A video-recording apparatus comprising
a recording medium operable to store data in both a writable and readable manner;
a read-write unit operable to read data from and write data to said recording medium;
a video data-acquiring unit operable to acquire video data;
an input unit operable to receive input from a user; and
a control unit operable to control said read-write unit, said video data-acquiring unit, and said input unit, to control said read-write unit to execute user recording when a user recording condition specified through said input unit is satisfied, but otherwise to control said read-write unit to temporarily record the video data obtained by said video data-acquiring unit,
wherein video data obtained by the user recording and video data obtained by temporary recording are recorded on said recording medium at a same region of said recording medium.

3. A video-recording apparatus as defined in claim 2, further comprising:
a compression unit disposed between said video data-acquiring unit and said read-write unit, said compression unit being operable to compress the video data acquired by said video data-acquiring unit, and to feed the compressed video data into said read-write unit.

4. A video-recording apparatus as defined in claim 2, wherein said control unit is operable to manage the video data recorded on said recording medium in accordance with attribute information associated with the video data, and wherein the attribute information includes identification information that distinguishes the video data obtained by the user recording from the video data obtained by the temporary recording.

5. A video-recording apparatus as defined in claim 4, wherein said control unit is operable to control rewriting of the identification information based on input from the user through said input unit.

6. A video-recording apparatus as defined in claim 2, wherein said control unit controls said read-write unit to perform reduction processing to reduce an information quantity of the video data recorded on said recording medium when said recording medium runs out of a void recording space, and when a predetermined condition is satisfied.

7. A video-recording apparatus as defined in claim 6, wherein the reduction processing reduces the video data obtained by the temporary recording in preference to the video data obtained by the user recording.

8. A video-recording apparatus as defined in claim 6, wherein the attribute information includes earlier and later recording time of the video data, and wherein the reduction processing reduces video data having the earlier recording time in preference to video data having the later recording time.

9. A video-recording apparatus as defined in claim 6, wherein the reduction processing is performed on a program basis.

10. A video-recording apparatus as defined in claim 6, wherein the reduction processing is performed on a partial program basis.

11. A video-recording apparatus as defined in claim 6, wherein the attribute information includes protection information to both prohibit and allow the reduction processing of the video data, the protection information being rewritable according to input from the user through said input unit, and wherein video data having the protection information to prohibit the reduction processing are never reduced.

12. A video-recording apparatus as defined in claim 6, wherein the reduction processing deletes the video data.

13. A video-recording apparatus as defined in claim 6, wherein the reduction processing compresses the video data at a ratio greater than that of the video data that are not reduced.

14. A video-recording apparatus as defined in claim 4, wherein the attribute information is retained in a table different from the video data.

15. A video-recording apparatus as defined in claim 4, wherein the attribute information is retained as a header of the video data.
